(19) United States
(12) Patent Application Publication
(10) Pub. No.: US 2008/0060884 A1
(43) Pub. Date: Mar. 13, 2008

(54) Elevator installation

(75) Inventor: Guenter Reuter, Filderstadt (DE)

Correspondence Address: Lipsitz & McAllister, LLC, 755 MAIN STREET, MONROE, CT, 06468, US

(73) Assignee: ThyssenKrupp Elevator AG, Duesseldorf (DE)

(21) Appl. No.: 11/899,990

(22) Filed: Sep. 7, 2007

Related U.S. Application Data
(63) Continuation of application No. PCT/EP2005/011541, filed on Oct. 28, 2005.

(30) Foreign Application Priority Data
Mar. 12, 2005 (EP) 05 005 443.6

(51) Int. Cl. B66B 7/10

(52) U.S. Cl. 187/412

(57) ABSTRACT

The invention relates to an elevator installation with at least one car, which can be made to travel in a shaft and is connected to a counterweight by means of two cable strands, which are associated with different sides of the car, and with a traction sheave, which can be driven by a motor and over which the two cable strands are led, the car being kept in a suspension ratio of 1:1. In order to develop the elevator installation in such a way that different extension behavior of the two cable strands can be equalized, it is proposed according to the invention that the two cable strands are coupled to each other by means of a cable length equalizing device disposed on the car and/or on the counterweight.

This application is a continuation of international application number PCT/EP2005/011541 filed on Oct. 28, 2005.

The present disclosure relates to the subject matter disclosed in international application number PCT/EP2005/011541 of Oct. 28, 2005 and European application number 05 005 443.6 of Mar. 12, 2005, which are incorporated herein by reference in their entirety and for all purposes.

### BACKGROUND OF THE INVENTION

The invention relates to an elevator installation with at least one car, which can be made to travel in a shaft and is connected to a counterweight by means of two cable strands, which are associated with different sides of the car, and with a traction sheave, which can be driven by a motor and over which the two cable strands are led, the car being kept in a suspension ratio of 1:1.

Elevator installations of this type are known from EP-A-1 329 412. In the case of this elevator installation, two cars which can be made to travel up and down independently of each other in a shaft are used. The upper car is connected to a traction sheave and a counterweight by means of a single cable strand, comprising a number of individual cables. Starting from this counterweight, the cable strand is then led to a traction sheave of the lower car, and the cable strand is subsequently divided into two cable strands, which run at a distance from each other and are respectively associated with one side of the lower car. The lateral disposition of the two cable strands of the lower car makes it possible to lead the cable strands respectively past one side of the upper car, the latter assuming a position between the two cable strands. Each of the two cars has a drive of its own, which is coupled to the respective traction sheave and is used to set it in rotation.

The use of two cable strands disposed at a distance from each other for driving a car generally has the result that the two cable strands undergo different degrees of extension, since the cable strands are generally led over different paths with different bending loads. Different extension behavior of the cable strands cannot be ruled out even if the car is subjected to uniform loading, since the cable strands are generally exposed to different frictional conditions. The different extension behavior may have the result that the car held on the two cable strands is slanted. It is therefore known to mount the cable strands on the car by means of spring elements. However, the different extension behavior of the cable strands cannot in all cases be completely compensated by means of spring elements of this type, since the spring elements with their customary spring length are not adequate for complete equalization, in particular in the case of long cable strands.

In particular in the case of high-speed elevators, in which at least one car is made to travel at speeds of usually over 4 m/s with the aid of two cable strands, the different extension behavior of the two cable strands is not negligible. In order to keep down running noises and vibrations of the car and also noises of the deflecting rollers and cable strands in the car even at relatively high speeds, the car is kept in a suspension ratio of 1:1, so that the change in height of the car is identical to the advancement of the cable strands, and consequently there is no relative movement between the cable strands and the car.

It is an object of the invention to develop an elevator installation of the type mentioned at the beginning in such a way that different extension behavior of the two cable strands can be equalized.

### SUMMARY OF THE INVENTION

This object is achieved according to the invention in the case of an elevator installation of the generic type by the two cable strands being coupled to each other by means of a cable length equalizing device disposed on the car and/or on the counterweight.

By means of the cable length equalizing device it is possible to equalize different extension behavior of the two cable strands, in particular it is possible to compensate for relatively great differences in length of the two cable strands occurring during the operation of the elevator installation in spite of the suspension ratio of 1:1 with the cable strands led over two different paths. In the case of the elevator installation according to the invention, the two cable strands are loaded with the same tensile force, so that virtually the same frictional behavior is obtained for both cable strands in the region of the traction sheave. Furthermore, a slanted position of the car is avoided.

The cable length equalizing device may be positioned on the car or else on the counterweight. For example, it may be disposed above or below the car or the counterweight. The term car is used here to refer both to a car cabin that can be entered by the user, without a car frame, and to a car cabin including a car frame, on which the car cabin is held.

In the case of a particularly preferred embodiment of the elevator installation according to the invention, the cable length equalizing device has two connecting links, by means of which the two cable strands are operatively connected to the car or the counterweight, the cable strands being coupled to each other between the two connecting links or by means of the two connecting links. The cable strands act in each case on a connecting link which is associated with the respective cable strand. The connecting link is preferably disposed alongside a plane defined by the side of the car or the counterweight that is associated with the respective cable strand.

In many cases, the cable strands comprise a number of individual cables. Here it is of advantage if the connecting links comprise a number of connecting elements, each individual cable being associated with a connecting element and individual cables of the two cable strands being coupled to each other between the respective connecting elements and/or by means of the respective connecting elements. A configuration of this type has the advantage that a cable length equalization, and with it also a tension equalization, is made possible between individual cables of the two cable strands, so that different extension behavior of the individual cables can be equalized.

It is of advantage if an arresting device is disposed between the connecting links for the nondisplaceable securement of the cable strands in relation to the car or the counterweight. A configuration of this type provides the possibility of preventing a cable length equalization under certain operating conditions of the elevator installation, for example if there is an operational fault. In this case, nondisplaceable securement of the two cable strands with respect to the car or the counterweight can be ensured by means of the arresting device. During normal operation of the elevator installation, the arresting device can be deactivated, so that a cable length equalization is possible during normal operation of the elevator installation.

The arresting device may comprise, for example, a cable clamp, with which the cable strands can be nondisplaceably fixed to the car or to the counterweight.

It is of particular advantage if at least one cable tension equalizing element is associated with the connecting links for equalizing the cable tensions existing in the cable strands. By means of the cable tension equalizing elements, it is possible in addition to equalizing the cable lengths to counteract directly a difference in the cable tensions, in that the cable tension is increased in one cable strand and reduced in the other cable strand.

If the cable strands have a number of individual cables, it is of particular advantage if the connecting links have a number of associated cable tension equalizing elements for equalizing the cable tensions prevailing in the individual cables. In this way it is possible to ensure in a structurally simple way that the individual cables of a cable strand have virtually the same cable tension and are therefore loaded in the same way and not overloaded.

The at least one cable tension equalizing element may interact in different ways with at least one cable strand and a connecting link. For example, it may be provided that a cable tension equalizing element is disposed between a cable strand and a connecting link.

Alternatively or in addition, it may be provided that a cable tension equalizing element is disposed between a connecting link and the car or the counterweight.

In the case of a structurally particularly simple configuration, the cable tension equalizing element comprises a spring element.

It may also be provided that the two connecting links are coupled to each other by means of a cable length equalizing element. The connecting links may in this case be movably held on the car or on the counterweight, so that a difference in the cable lengths of the two cable strands can be equalized by moving at least one connecting link.

It is of advantage if the cable length equalizing element has a linear adjusting system, for example a linear drive element, in particular an electrical, mechanical, hydraulic or pneumatic drive element for a straight (linear) movement, for example a hydraulic or pneumatic piston-cylinder assembly. The use of a linear adjusting system has the advantage that a difference in the cable lengths of the two cable strands can be actively counteracted by means of an electrical, mechanical, hydraulic or pneumatic adjusting element, in that the linear adjusting system is activated in a way corresponding to an actual difference in cable lengths and is consequently lengthened and/or shortened.

In the case of a particularly preferred embodiment, the connecting links are disposed at a distance from each other and the two cable strands are connected to each other between the connecting links, preferably integrally connected. A configuration of this type provides the possibility of leading the cable strands that are connected to each other around the connecting links and thereby achieving a direct tension and length equalization between the cable strands.

In the case of a structurally simple configuration of the elevator installation according to the invention, the connecting links are configured as deflecting elements around which a cable strand is respectively led. Here it may be provided that the cable strands are held on the respective deflecting element in a sliding manner, so that they can be displaced in relation to the deflecting element, in order to equalize unequal tensile loading of the two cable strands.

The deflecting elements are preferably configured as freely rotatable deflecting rollers.

If the two cable strands comprise a number of individual cables, it is of advantage if the deflecting rollers have a number of deflecting sheaves, each individual cable being led around a separate deflecting sheave. This makes possible particularly simple tension and length equalization between the individual cables of the two cable strands.

In order to avoid individual cables influencing each other during a length equalization, it is of advantage if the deflecting sheaves of a deflecting roller are held rotatably in relation to each other. In the case of an embodiment of this type, the deflecting sheaves may rotate independently of each other, so that, in the case of a cable length equalization, only the individual cable concerned is moved in each case, while the other individual cables of the cable strand do not undergo any relative movement.

It may be provided that the deflecting elements are held on a common carrier, which is disposed on the car or on the counterweight.

Alternatively, it may be provided that the deflecting elements are respectively held on a separate carrier, which is disposed on the car or on the counterweight. The carriers may, for example, in each case form a bearing support, on which a deflecting element in the form of a deflecting roller is mounted in a freely rotatable manner.

The deflecting elements are preferably held on the car or on the counterweight by means of a spring element. The spring element not only makes possible the equalization of different cable lengths and cable tensions, but also ensures very low-vibration mounting of the car or the counterweight. Alternatively or in addition, it may be provided that the deflecting elements are held on the car or on the counterweight by means of a linear adjusting system, for example a piston-cylinder assembly. By activation of the linear adjusting system, the deflecting elements can be moved in relation to the car or the counterweight.

It is of advantage if the distance between the deflecting elements can be changed. For example, it may be provided that the deflecting elements respectively protrude beyond one side of the car or the counterweight and are movably held perpendicular to the plane defined by the respective side of the car or counterweight, in order as a result to change the distance between the deflecting elements. Similarly, the equalizing movement of the deflecting elements may also take place in a vertical direction.

Instead of forming the connecting links in the form of deflecting elements, it is provided in the case of an advantageous embodiment of the invention that the connecting links respectively form a pivotably mounted lever arm, on which a cable strand is held. By pivoting the lever arm, a cable length equalization can be achieved in a structurally simple way.

If the cable strands have a number of individual cables, it is of advantage if the lever arms have a number of lever arm elements, on which an individual cable is respectively held. This allows different extension behavior of the individual cables of a cable strand to be equalized.

It is preferred for the two lever arms to be rigidly connected to each other and form a rocker. The rocker may, for example, be mounted on a bearing support protruding from the car.

The rocker is preferably pivotably held in the region of a vertical center axis of the car or of the counterweight. In the case of a configuration of this type, the rocker is symmetrically formed in such a way that the two lever arms are in each case of the same length.

It is of particular advantage if the individual cables of the two cable strands are respectively coupled to each other by means of a rocker. The individual cables may be respectively disposed on a cable tension equalizing element at the ends of the rocker. The cable tension equalizing elements may be configured for example as one-part or multi-part springs.

It may be provided that the two cable strands have a different number of individual cables. A configuration of this type may be of advantage in particular in the case of high shafts. It is advantageous to use a rocker which is pivotably held offset in the direction of the cable strand with the greater number of individual cables in relation to the vertical center axis of the car or of the counterweight. The cable strand with the greater number of individual cables is consequently held on a shorter lever arm than the cable strand with the smaller number of individual cables. Consequently, in spite of the different number of individual cables, a cable length equalization, and with it also a tension equalization, can be achieved between the cable strands in a simple way.

The pivoting movement of the rocker can preferably be monitored by means of a sensor. For this purpose, a contactless sensor, for example a magnetic field sensor, preferably a Hall sensor, may be used in particular, or else a customary incremental encoder, which is coupled to the pivoting axis of the rocker. It is also possible to monitor the approach of a lever arm of the rocker to the car, in that the distance between the lever arm and the car is sensed by means of a sensor.

To be able to detect a very great change in length of one of the two cable strands, it is advantageous if a control signal can be output by the sensor when a predetermined pivoting angle of the rocker or a predetermined distance between the lever arm and the car is exceeded. The control signal may be presented to an elevator control system of the elevator installation, so that, if the control signal is received, the elevator control system can output an optical or acoustic warning signal in order to indicate to the user that the two cable strands have very different cable lengths, for example because the cable strands have been in use for a relatively long time.

In the case of a particularly preferred embodiment of the invention, the two connecting links are respectively configured as pivotably mounted angle levers, with a first side arm and a second side arm aligned at an angle, preferably at right angles, to said first side arm, a cable strand being held on the first side arm and the second side arms being connected to each other by means of a coupling link. The first side arms may respectively protrude beyond a side wall of the car or of the counterweight and point in opposite directions, a cable strand being respectively held alongside the free end of the first side arm. The cable strand may be rigidly connected to the respective side arm. However, it is of particular advantage if the cable strand is fixed to the first side arm by means of a cable tension equalizing element, in particular a spring element. The second side arms may be vertically aligned, being connected to each other by means of the coupling link.

The coupling link may comprise a spring element, which is clamped between the two side arms.

Alternatively or in addition, it may be provided that the coupling link has a linear adjusting system, so that the second side arms are for example electrically, mechanically, pneumatically or hydraulically coupled to each other.

If the cable strands have a number of individual cables, it is advantageous if the angle levers respectively comprise a number of angle lever elements with a first and a second side arm, an individual cable being respectively held on a first side arm of an angle lever element, preferably by means of a cable tension equalizing element, and the second side arms of two angle lever elements being connected to each other by means of coupling links of their own in each case. In this way, different cable lengths of individual cables can be counteracted particularly effectively. The angle lever elements are preferably pivotably held in relation to each other.

The following description of preferred embodiments of the invention serves for more detailed explanation in conjunction with the drawings.

### BRIEF DESCRIPTION OF THE DRAWINGS

FIG. 1 shows a schematic representation of a first embodiment of an elevator installation according to the invention;

FIG. 2 shows a schematic representation of a second embodiment of an elevator installation according to the invention;

FIG. 3 to 9 show schematic representations of third to ninth embodiments of the elevator installation according to the invention in the form of cutout details.

### DETAILED DESCRIPTION OF THE INVENTION

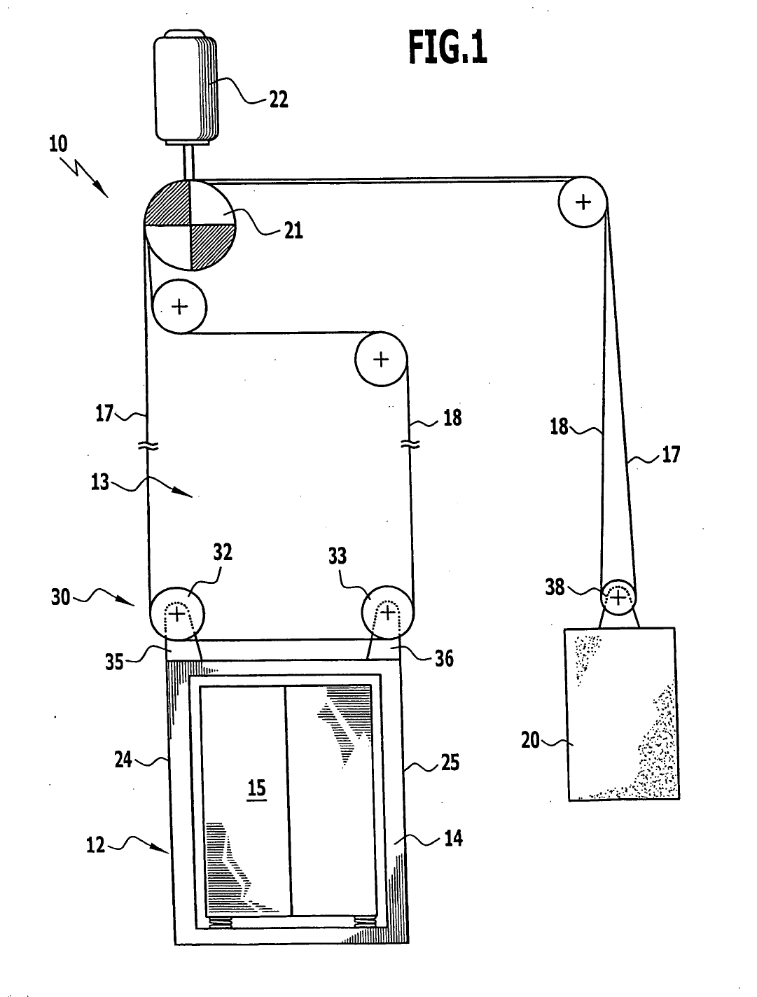

In FIG. 1, an elevator installation 10 is represented, with a car 12, which can be made to travel in a shaft 13 for transporting persons and/or loads and has a car frame 14 and a car cabin 15. The car 12 is connected by means of two cable strands 17, 18 to a counterweight 20 in a suspension ratio of 1:1, the cable strands 17, 18 being led over a common traction sheave 21, which can be driven in a rotating manner by means of a drive 22. The cable strands 17 and 18 are each associated with one side 24 and 25, respectively, of the car.

On its upper side, the car carries a cable length equalizing device 30, with two connecting links disposed at a distance from each other in the form of two deflecting rollers 32, 33, around each of which a car-side end region of the cable strands 17 and 18, respectively, is led. The two deflecting rollers 32, 33 are each mounted in a freely rotatable manner on a carrier in the form of a bearing support 35 and 36, respectively, rigidly connected to the car 12. Between the two deflecting rollers 32, 33, the two cable strands 17, 18 are integrally connected to each other.

The cable strands 17, 18 are also integrally connected to each other in the region of the counterweight 20 and are led around the counterweight roller 38, which is mounted in a freely rotatable manner on the upper side of the counterweight 20.

If there is a different extension of the two cable strands 17, 18, for example because very long cables have been in use for a relatively long time or else because of unsymmetrical weight loading of the car 12, the accompanying change in length can be equalized by displacement of the connecting region of the cable strands 17, 18 with respect to the car 12 as a result of the integral connection of the two cable strands 17, 18 and their securement on the car 12 by means of the deflecting rollers 32, 33.

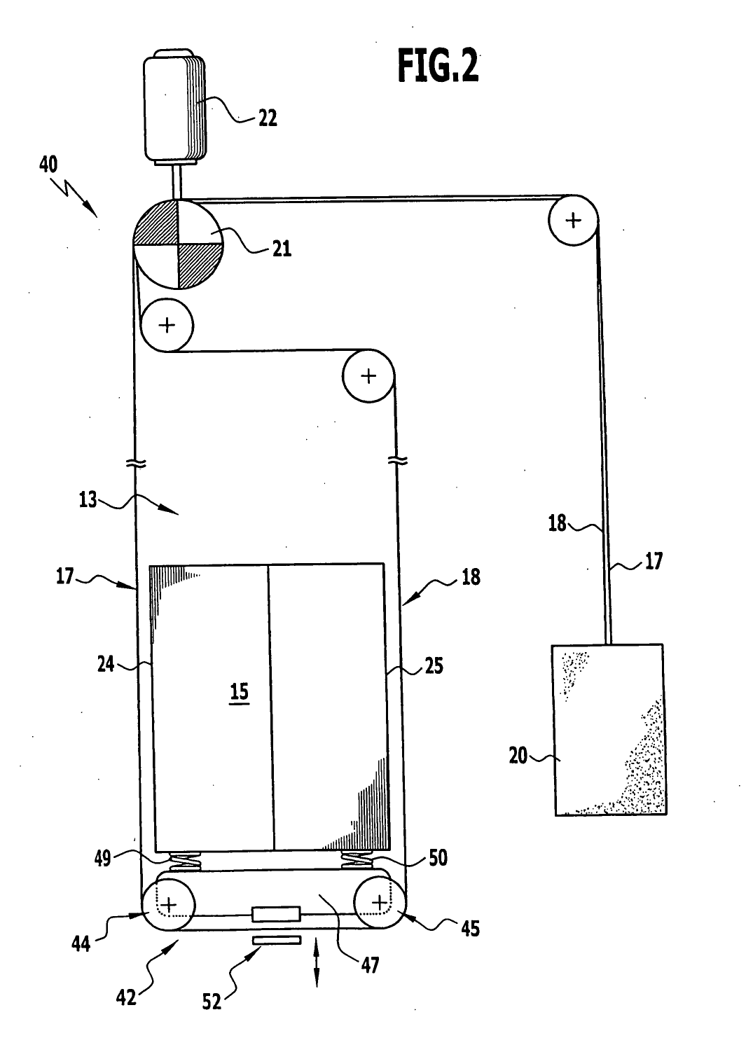

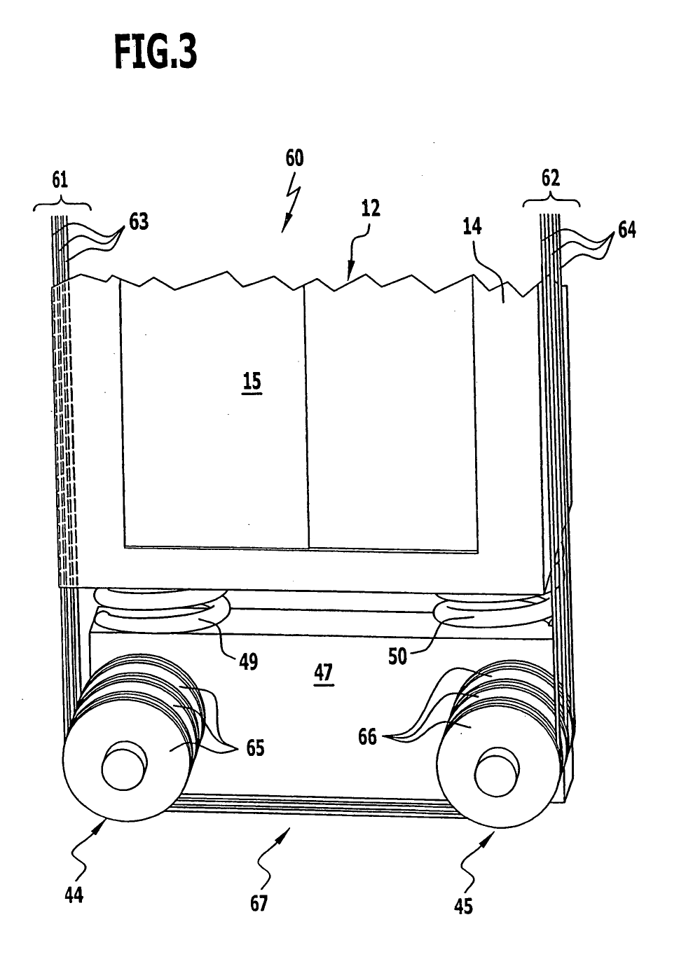

In FIG. 2, a second embodiment of an elevator installation according to the invention is represented and provided overall with the reference numeral 40. In the same way as the embodiments that are represented in FIGS. 3 to 9 and described in detail below, this elevator installation is configured largely identically to the elevator installation 10. Therefore, the same reference numerals as in FIG. 1 are used for identical components in FIGS. 2 to 9. To avoid repetition, reference is made in this respect to the explanations given above.

The elevator installation 40 represented in FIG. 2 differs from the elevator installation 10 in that a cable length equalizing device 42 is disposed underneath the car cabin 15. This device comprises deflecting rollers 44 and 45, which are respectively mounted in a freely rotatable manner on a common carrier 47, which is held on the car cabin 15 by means of spring elements 49, 50. A car frame, as used in the case of the elevator installation 10 represented in FIG. 1, is not used in the case of the elevator installation 40.

In the case of the elevator installation 40, too, the cable strands 17, 18 are integrally connected to each other in the region between the deflecting rollers 44 and 45, interacting in this region with an arresting device in the form of a cable clamp 52. By means of the cable clamp 52, the two cable strands 17, 18 can be held nondisplaceably in relation to the car cabin 15, in that they are firmly clamped on the carrier 47. In this way it is possible, for example in the case of an operational fault, to prevent a length equalization between the cable strands 17 and 18, whereby the car cabin 15 could then alternatively also be moved by only one cable strand 17 or 18.

The elevator installation 40 also differs from the elevator installation 10 in that the two cable strands 17 and 18 are fixed directly to the counterweight 20. A counterweight roller, as is used in the case of the elevator installation 10, is not used in the case of the elevator installation 40.

In FIG. 3, a third embodiment of an elevator installation is represented in the form of a cutout detail and provided overall with the reference numeral 60. In the case of this elevator installation, cable strands 61 and 62 are used, each having a number of individual cables 63 and 64, respectively. In a way corresponding to the embodiment represented in FIG. 2, the cable strands 61 and 62 are led around deflecting rollers of a cable length equalizing device 67 that are mounted on the underside of the car 12, but each individual cable 63 and 64 has a separate associated deflecting sheave 65 and 66, respectively, of the deflecting rollers. The individual deflecting sheaves 65 and 66 are rotatably held in relation to each other on the carrier 47, so that a length equalization can take place in each case between two individual cables 63 and 64 of the two cable strands 61 and 62, respectively, without the other individual cables 63 and 64 being influenced by it. It may also be provided here that each deflecting roller, and in particular each deflecting sheave 65, 66, is separately held in a resilient manner. The resilient mounting of the carrier 47 by means of the spring elements 49, 50 is then not required.

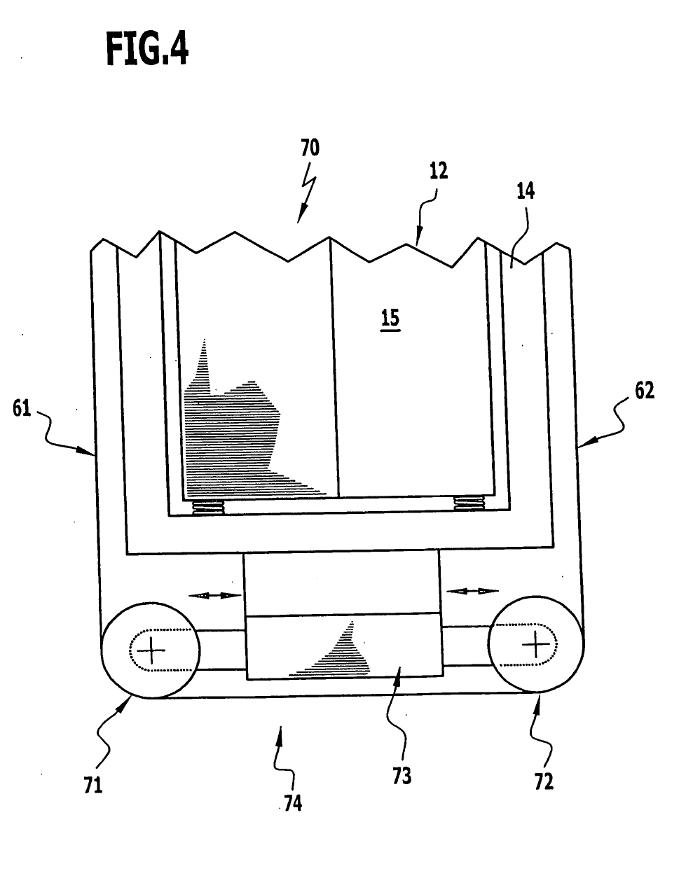

In FIG. 4, a fourth embodiment of an elevator installation according to the invention, with a cable length equalizing unit 74, is represented and provided overall with the reference numeral 70, in which installation deflecting rollers 71 and 72 disposed on the underside of the car 12 are held on a cable length equalizing element in the form of a hydraulic piston-cylinder assembly 73, which is fixed to the underside of the car 12. The piston-cylinder assembly 73 forms a linear adjusting system, with the aid of which the deflecting rollers 71, 72 can be displaced in opposite directions in relation to each other, in order to change the distance between the deflecting rollers 71 and 72. By changing this distance, changes of the cable lengths of the cable strands 61, 62 can be specifically equalized. In the case of this embodiment, too, the deflecting rollers 71, 72 may, as already shown in FIG. 3, comprise individual deflecting sheaves which can rotate in opposite directions and around each of which an individual cable of the cable strands 61, 62 is led. Each deflecting sheave of the deflecting roller 71 may be coupled to a deflecting sheave of the deflecting roller 72 by means of a piston-cylinder assembly 73, so that the cable lengths of the individual cables of the cable strands 61, 62 can be individually equalized.

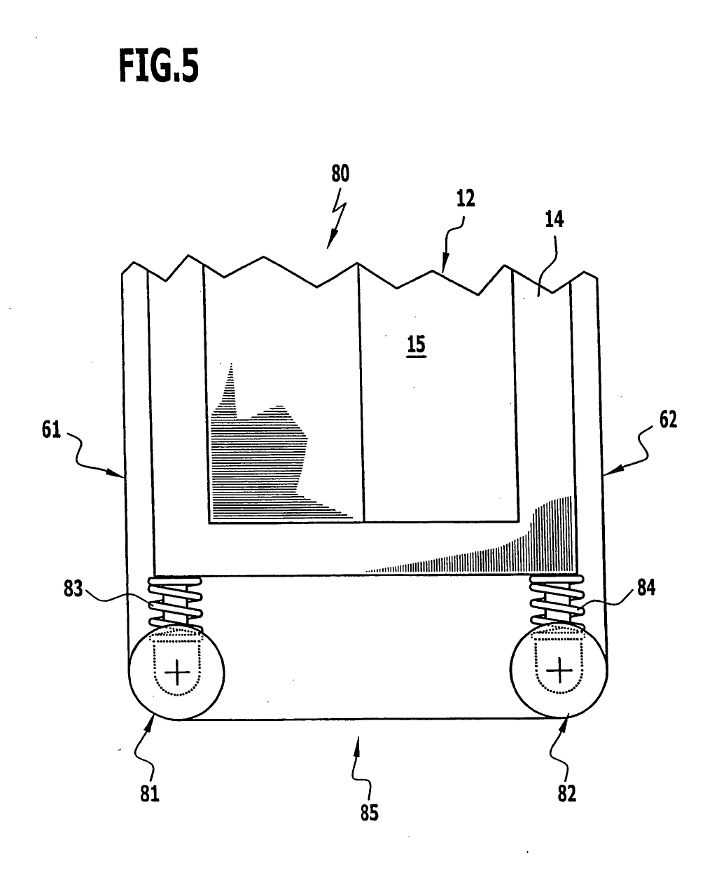

In FIG. 5, a fifth embodiment of an elevator installation according to the invention, with a cable length equalizing device 85, is represented and provided overall with the reference numeral 80, in which installation two deflecting rollers 81, 82 are used, in each case mounted in a freely rotatable manner on the underside of the car 12 by means of a cable tension equalizing element in the form of a spring element 83 and 84, respectively. The cable strands 61, 62 are integrally connected to each other in the region between the deflecting rollers 81 and 82, so that a length equalization can take place between the cable strands 61, 62 during the operation of the elevator installation 80. The mounting of the deflecting rollers 81 and 82 by means of the spring elements 83 and 84, respectively, makes it possible to counteract different cable tensions of the cable strands 61, 62 in a structurally simple way. Once again, the deflecting rollers 81, 82 may have individual deflecting sheaves which can rotate in opposite directions and around each of which an individual cable of the cable strands 61, 62 is led. The individual deflecting sheaves may be respectively mounted on the car 12 by means of a separate spring element 83, 84, so that the cable tensions of the individual cables can be individually equalized.

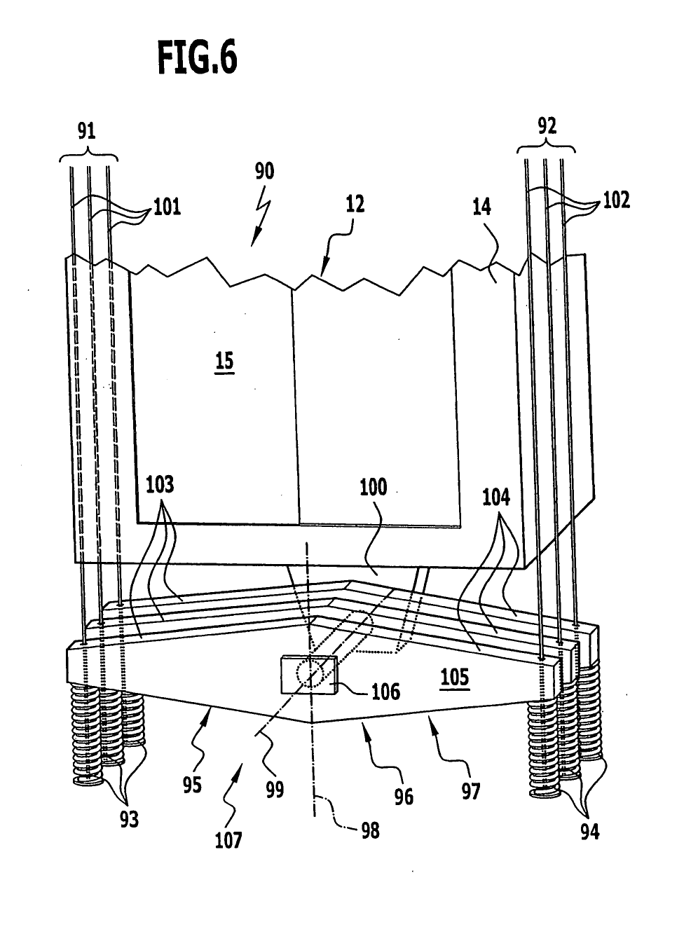

In the case of the embodiments of the elevator installation according to the invention that are explained above, the two cable strands are integrally connected to each other. By contrast with this, in FIG. 6 a sixth embodiment of an elevator installation according to the invention is represented and provided with the reference numeral 90, with a cable length equalizing device 107, in the case of which cable strands 91 and 92 are fixed at the ends to a lever arm 95 and 96, respectively, by means of cable tension equalizing elements in the form of spring elements 93 and 94, respectively. The two lever arms 95, 96 are integrally connected to each other and form a rocker 97, which is mounted pivotably about a horizontally aligned pivot axis 99 in the region of a vertical center axis 98 of the car 12 on a carrier 100, which is rigidly connected to the car 12.

The cable strands 91 and 92 have in each case a number of individual cables 101 and 102, respectively, and the lever arms 95 and 96 in each case comprise lever arm elements 103 and 104, respectively, to each of which an individual cable 101 and 102, respectively, is fixed by means of a spring element 93 and 94, respectively. Two lever arm elements respectively form a rocker element 105, which is pivotably mounted with respect to the remaining rocker elements 105 on the carrier 100.

All the rocker elements 105 respectively interact with an angular resolver 106, with the aid of which the pivoting position of the rocker element 105 can be sensed and which presents a control signal if a maximum permissible and predeterminable pivoting angle of an elevator control system that is known per se (and therefore not represented in the drawing) is exceeded, so that said control system can output a warning signal if the permissible pivoting angle is exceeded.

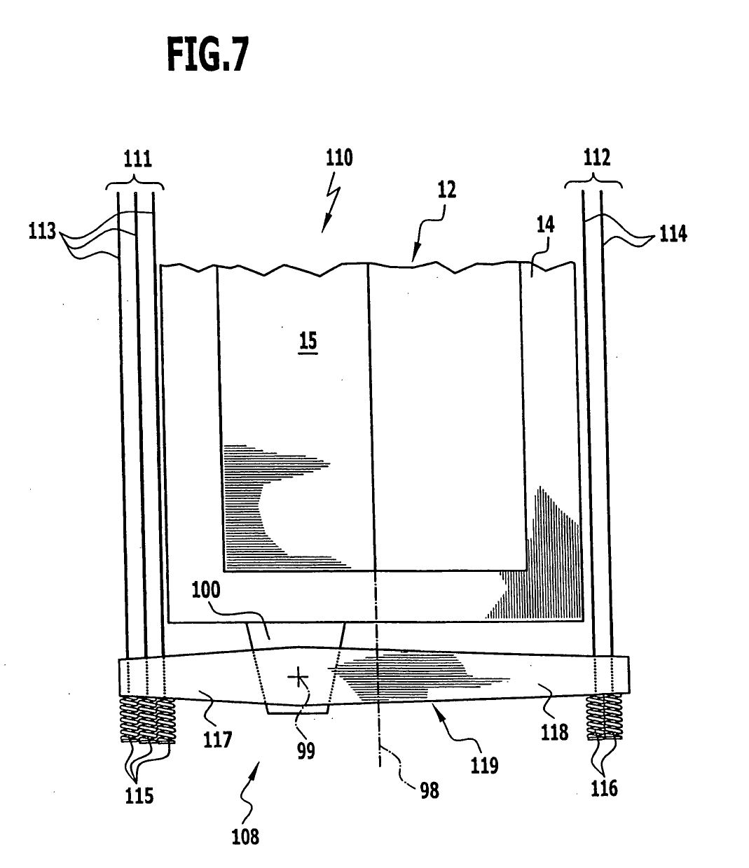

A seventh embodiment of an elevator installation according to the invention, with a cable length equalizing device 108, is represented in FIG. 7 in the form of a cutout detail and is provided overall with the reference numeral 110. In the case of this elevator installation, two cable strands 111 and 112, which have a different number of individual cables 113 and 114, respectively, are used. The individual cables 113 and 114 are in each case fixed to a lever arm 117 and 118, respectively, by means of cable tension equalizing elements in the form of spring elements 115 and 116, respectively. The lever arms 117 and 118 respectively form a connecting link of the cable length equalizing device 108 and are pivotably mounted on the carrier 100. The lever arm 117, on which the cable strand 111 with the greater number of individual cables 113 is resiliently held, is shorter than the lever arm 118, which resiliently mounts the individual cables 114 of the cable strand 112. The two lever arms 117, 118 form a rocker 119, which, as a difference from the embodiment represented in FIG. 6, is pivotably mounted offset in relation to the vertical center axis 98 on the carrier 100. Consequently, in spite of the use of cable strands 111, 112 with a different number of individual cables 113 and 114, respectively, an equally high loading and a length equalization of the cable strands 111, 112 can be achieved by means of the rocker 119. In addition, an equalization of the cable tensions existing in the individual cables 113, 114 is possible by means of the spring elements 115 and 116.

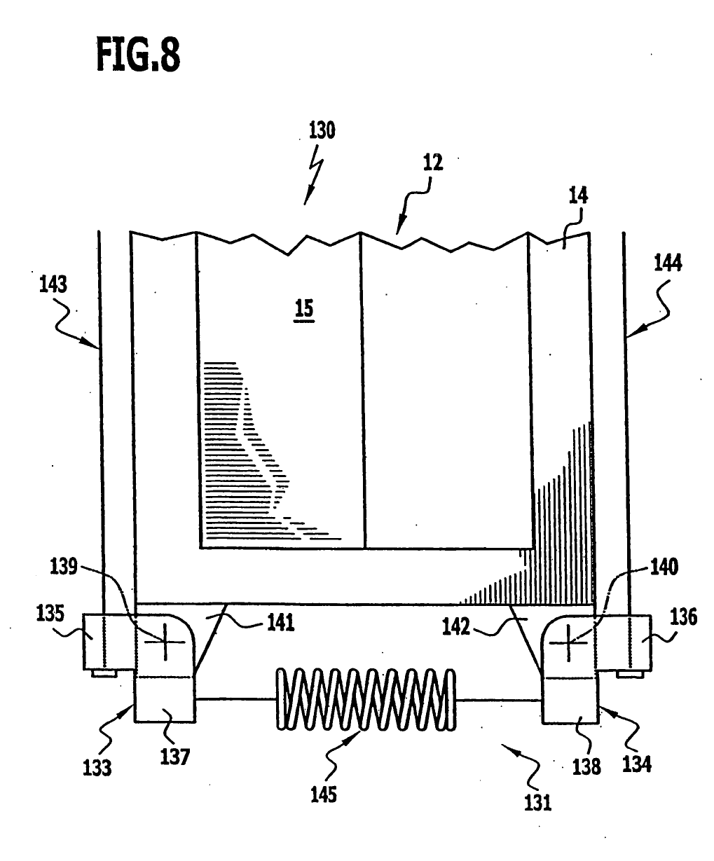

In FIG. 8, an eighth embodiment of an elevator installation according to the invention is represented and provided overall with the reference numeral 130, in which installation a cable length equalizing device 131 is used, having two connecting links disposed at a distance from each other in the form of two angle levers 133, 134, each with a first side arm 135 and 136, respectively, and, aligned at right angles to the latter, a second side arm 137 and 138, respectively. The angle levers 133, 134 are held pivotably about horizontal pivot axes 139 and 140, respectively, on carriers 141 and 142, respectively, which are fixed to the underside of the car 12. Fixed to each of the free ends of the first side arms 135, 136 is a cable strand 143 and 144, respectively, and the two side arms 137, 138 are connected to each other by means of a coupling link in the form of a tension spring 145. By pivoting the angle levers 133, 134, different extension behavior of the two cable strands 143, 144 can be equalized, the cable tensions of the two cable strands 143, 144 also being equalized by means of the tension spring 145.

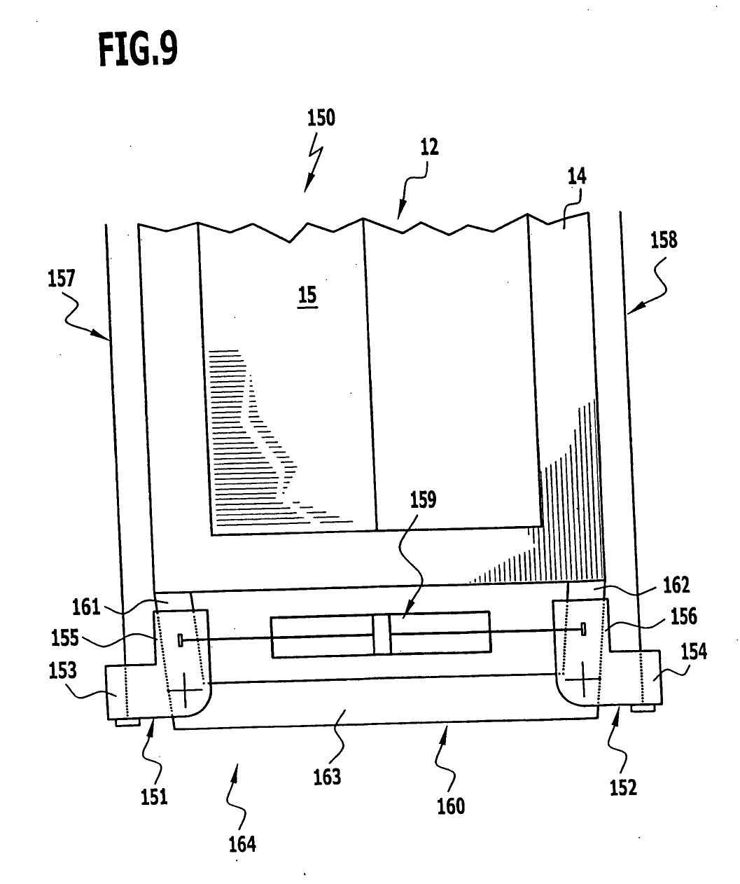

In FIG. 9, a ninth embodiment of an elevator installation according to the invention, with a cable length equalizing device 164, is represented and provided overall with the reference numeral 150, in which installation two angle levers 151 and 152 are used in a way corresponding to the elevator installation 130, each with a first side arm 153 and 154, respectively, and a second side arm 155 and 156, respectively. Once again, fixed to each of the first side arms 153, 154 is a cable strand 157 and 158, respectively. By contrast with the elevator installation 130, however, the second side arms 155, 156 are not coupled to each other by means of a tension spring but by means of a linear adjusting system in the form of a hydraulic piston-cylinder assembly 159. Furthermore, the two angle levers 151, 152 are mounted on a common carrier 160, which is formed in a substantially U-shaped manner and has two carrying arms 161, 162, which are fixed to the car 12 and are integrally connected to each other by means of a carrying cross-piece 163. The piston-cylinder assembly 159 is held between the two carrying arms 161, 162 and is consequently covered on the upper side by the car 12 and on the underside by the carrying cross-piece 163. It forms a cable length equalizing element for equalizing different cable lengths of the cable strands 157, 158.

In the case of the cable length equalizing devices 131 and 164, too, the cable strands 143, 144 and 157, 158, respectively, may have a number of individual cables, associated with each of which is a separate angle lever 133, 134 and 151, 152, respectively, an angle lever 133 and 151 in each case being coupled to an associated angle lever 134 and 152, respectively, by means of a separate coupling link 145 or 159. Consequently, in the case of the embodiments represented in FIGS. 8 and 9, too, the cable lengths of individual cables of the cable strands 143, 144 and 157, 158, respectively, can also be equalized independently of the cable lengths of the remaining individual cables. In particular in the case of the cable length equalizing device 164 represented in FIG. 9, it may also be provided that the individual cables of the cable strands 157, 158 are in each case held on the respective angle lever 151 and 152, respectively, by means of a spring element, such as that which is for example represented in FIG. 6 and provided with the reference numerals 93, 94. The spring elements make possible an equalization of the cable tensions of the individual cables.

1. Elevator installation with at least one car, which can be made to travel in a shaft and is connected to a counterweight by means of two cable strands, which are associated with different sides of the car, and with a traction sheave, which can be driven by a motor and over which the two cable strands are led, the car being kept in a suspension ratio of 1:1, wherein the two cable strands are coupled to each other by means of a cable length equalizing device disposed on the car and/or on the counterweight.

2. Elevator installation according to claim 1, wherein the cable length equalizing device is disposed above or below the car or the counterweight.

3. Elevator installation according to claim 1, wherein the cable length equalizing device has two connecting links, by means of which the two cable strands are operatively connected to the car or the counterweight, the cable strands being coupled to each other between the two connecting links or by means of the two connecting links.

4. Elevator installation according to claim 3, wherein the cable strands have a number of individual cables and the connecting links comprise a number of connecting elements, each individual cable being associated with a connecting element and individual cables of the two cable strands being coupled to each other between the respective connecting elements and/or by means of the respective connecting elements.

5. Elevator installation according to claim 3, wherein an arresting device is disposed between the connecting links for the nondisplaceable securement of the cable strands in relation to the car or the counterweight.

6. Elevator installation according to claim 5, wherein the arresting device comprises a cable clamp.

7. Elevator installation according to claim 3, wherein at least one cable tension equalizing element is associated with the connecting links for equalizing the cable tensions prevailing in the cable strands.

8. Elevator installation according to claim 7, wherein the cable strands have a number of individual cables and the connecting links have a number of associated cable tension equalizing elements for equalizing the cable tensions prevailing in the individual cables.

9. Elevator installation according to claim 7, wherein at least one cable tension equalizing element is disposed between a cable strand and a connecting link.

10. Elevator installation according to claim 7, wherein at least one cable tension equalizing element is disposed between a connecting link and the car or the counterweight.

11. Elevator installation according to claim 7, wherein the cable tension equalizing element comprises a spring element.

12. Elevator installation according to claim 3, wherein the two connecting links are coupled to each other by means of a cable length equalizing element.

13. Elevator installation according to claim 12, wherein the cable length equalizing element comprises a linear adjusting system.

14. Elevator installation according to claim 3, wherein the connecting links are disposed at a distance from each other and the two cable strands are connected to each other between the connecting links.

15. Elevator installation according to claim 3, wherein the connecting links are configured as deflecting elements, which are disposed at a distance from each other and around which a cable strand is respectively led.

16. Elevator installation according to claim 15, wherein the deflecting elements are configured as freely rotatable deflecting rollers.

17. Elevator installation according to claim 16, wherein the two cable strands have a number of individual cables and the deflecting rollers comprise a number of deflecting sheaves, each individual cable being led around a separate deflecting sheave.

18. Elevator installation according to claim 17, wherein the deflecting sheaves of a deflecting roller are held rotatably in relation to each other.

19. Elevator installation according to claim 15, wherein the deflecting elements are held on a common carrier, which is disposed on the car or on the counterweight.

20. Elevator installation according to claim 15, wherein the deflecting elements are respectively held on a separate carrier, which is disposed on the car or on the counterweight.

21. Elevator installation according to claim 15, wherein the deflecting elements are held on the car or on the counterweight by means of a spring element.

22. Elevator installation according claim 15, wherein the deflecting elements are held on the car or on the counterweight by means of a linear adjusting system.

23. Elevator installation according to claim 15, wherein the distance between the deflecting elements is changeable.

24. Elevator installation according to claim 23, wherein the distance between the deflecting elements is changeable by means of a linear adjusting system.

25. Elevator installation according to one of claim 3, wherein the connecting elements respectively form a pivotably mounted lever arm, on which a cable strand is held.

26. Elevator installation according to claim 25, wherein the lever arms have a number of lever arm elements, on each of which an individual cable of the cable strand is held.

27. Elevator installation according to claim 26, wherein the lever arm elements of each lever arm are pivotably held in relation to each other.

28. Elevator installation according to claim 25, wherein the lever arms are rigidly connected to each other and form a rocker.

29. Elevator installation according to claim 28, wherein the rocker is pivotably held in the region of a vertical center axis of the car or of the counterweight.

30. Elevator installation according to claim 28, wherein the two cable strands have a different number of individual cables and the rocker is pivotably held offset in the direction of the cable strand with the greater number of individual cables in relation to the vertical center axis of the car or of the counterweight.

31. Elevator installation according to claim 28, wherein the elevator installation comprises a sensor adapted to monitor the pivoting movement of the rocker.

32. Elevator installation according to claim 31, wherein the sensor is adapted to output a control signal when a predetermined pivoting angle of the rocker is exceeded.

33. Elevator installation according to claim 3, wherein the two connecting links are configured as pivotably mounted angle levers, with a first side arm and a second side arm aligned at an angle to said first side arm, a cable strand being held on the first side arm and the second side arms being connected to each other by means of a coupling link.

34. Elevator installation according to claim 33, wherein the coupling link comprises a spring element.

35. Elevator installation according to claim 33, wherein the coupling link comprises a linear adjusting system.

36. Elevator installation according to claim 33, wherein the cable strands comprise a number of individual cables and the angle levers have a number of angle lever elements with a first and a second side arm, an individual cable being respectively held on a first side arm of an angle lever element and the second side arms of two angle lever elements being connected to each other by means of a coupling link.

37. Elevator installation according to claim 36, wherein the angle lever elements are pivotably held in relation to each other.
